(19) United States
(12) Patent Application Publication
(10) Pub. No.: US 2018/0295145 A1
(43) Pub. Date: Oct. 11, 2018

(54) Multicomputer Digital Data Processing to Provide Information Security Control

(71) Applicant: Bank of America Corporation, Charlotte, NC (US)

(72) Inventors: Scott Brow, McKinney, TX (US); Manikandan Balasubramanian, Addison, TX (US); Adriel D. Goddard, Plano, TX (US)

(73) Assignee: Bank of America Corporation, Charlotte, NC (US)

(21) Appl. No.: 15/484,659

(22) Filed: Apr. 11, 2017

(51) Int. Cl. H04L 29/06

(52) U.S. Cl. CPC H04L 63/1425; H04L 63/1433; H04L 63/1416

(57) ABSTRACT

Systems for performing information security control functions are provided. In some examples, a computing platform may receive an indication of an information security event. The indication may be received from one or more computing devices. In some examples, data associated with the information security incident may be received. For instance, data related to a device or application associated with the incident, name or type of incident, metadata associated with the incident, and the like, may be received. In some arrangements, a unique identifier may be generated. The unique identifier may then be associated with the incident, data associated with the incident, and the like. The data may be processed to extract one or more pieces of data. The extracted data may be stored in a database having a pre-configured data structure. Storing the extracted data may include storing the associated unique identifier with the data to enable tracking of incidents, and the like.

### BACKGROUND

Aspects of the disclosure relate to electrical computers and data processing systems. In particular, one or more aspects of the disclosure relate to implementing and using a data processing system to provide information security control functions.

Information security is of utmost importance in many different industries. In particular, large enterprise organizations may make every attempt to identify information security incidents, remediate incidents, and the like. However, due to the sheer volume of incidents and potential incidents to be analyzed and evaluated, conventional systems are time consuming, prone to error, and are limited in providing tracking information related to one or more information security incidents.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with providing information security control functions.

In some examples, a system, computing platform, or the like, may receive an indication of an information security event. The indication may be received from one or more computing devices that may monitor and/or evaluate issues such as scanner vulnerabilities, assessment or test findings, and the like. In some examples, the system, computing platform, or the like, may receive, in real-time, a content stream from the one or more computing devices and one or more information security incidents may be identified via the real-time content stream.

In some examples, data associated with the information security incident may be received. For instance, data related to a device or application associated with the incident, name or type of incident, metadata associated with the incident, and the like, may be received. In some arrangements, a unique identifier may be generated. The unique identifier may then be associated with the incident, data associated with the incident, and the like.

In some examples, the data may be processed to extract one or more pieces of data. The extracted data may be stored in a database having a pre-configured data structure. Storing the extracted data may include storing the associated unique identifier with the data to enable tracking of incidents, and the like.

In some examples, data stored in the database may be processed to modify data associated with an incident. For instance, as additional information related to an incident is received, remediation information is received, or the like, the data may be processed to store the additional information. In some arrangements, it may be desirable to remove one or more modifications or changes made to one or more data sets. Accordingly, the data set may be flagged for re-processing. Re-processing the data set may remove one or more modifications made to the data set. In some examples, re-processing may be performed upon occurrence of a triggering event.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing and using a data processing system to provide information security control functions in accordance with one or more aspects described herein;

FIGS. 2A-2D depict an illustrative event sequence for implementing and using a data processing system to provide information security control functions in accordance with one or more aspects described herein;

FIG. 3 depicts an illustrative method for implementing and using a data processing system to provide information security control functions, according to one or more aspects described herein;

FIG. 4 depicts an illustrative method of determining whether processes are available and processing data based on the determination according to one or more aspects described herein;

FIG. 5 depicts an illustrative method of re-processing items flagged for re-processing according to one or more aspects described herein;

FIG. 6 illustrates one example user interface for requesting information related to an information security incident according to one or more aspects described herein;

FIG. 7 illustrates one example user interface for providing information security incident information according to one or more aspects described herein.

FIG. 8 illustrates one example operating environment in which various aspects of the disclosure may be implemented in accordance with one or more aspects described herein; and

FIG. 9 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As indicated above, information security is an important concern for many large enterprise organizations. As information security incidents occur, organizations and users must evaluate the incidents, take action to remediate incidents, and the like. In some examples, information security incidents may include information security observations (e.g., data that has been identified for changes, updates, or the like), vulnerabilities identified, findings from one or more assessments, open share issues, and the like. The volume of incidents makes this work time consuming and prone to errors. In some arrangements, processes for tracking information security incidents are limited or do not exist. This makes monitoring particular incidents, devices, applications, or the like, as well as remediation efforts, difficult.

Accordingly, arrangements described herein are directed to a computing platform for performing information security control functions. In some examples, the computing platform may receive one or more information security incidents and associated data. In some examples, the computing platform may generate a unique identifier associated with the information security incident. For example, the computing platform may determine a device or application associated with the incident and may generate a unique identifier including a name or other identifier associated with the device or application, and a name or type of the incident. The unique identifier may then be associated with the information security incident and the associated data.

In some arrangements, the computing platform may process the data associated with the incident to extract information for storage in a database. For instance, the computing platform may extract data to be stored according to a pre-configured data structure. A database record may then be generated and the extracted data may then be mapped to the database record for the information security incident.

In some examples, additional information related to an information security incident may be received. For instance, data associated with remediation of the incident may be received. The computing platform may process that data and store it with the information security incident.

As indicated above, data may be modified based on additional data received, remediation efforts, and the like. However, in some examples, modifications to the data may be removed. Accordingly, a data set may be flagged for re-processing. Re-processing the data set may include removing one or more modifications made to the data set. Re-processing may be performed on items flagged for re-processing based on an occurrence of a triggering event.

These and various other arrangements will be discussed more fully below.

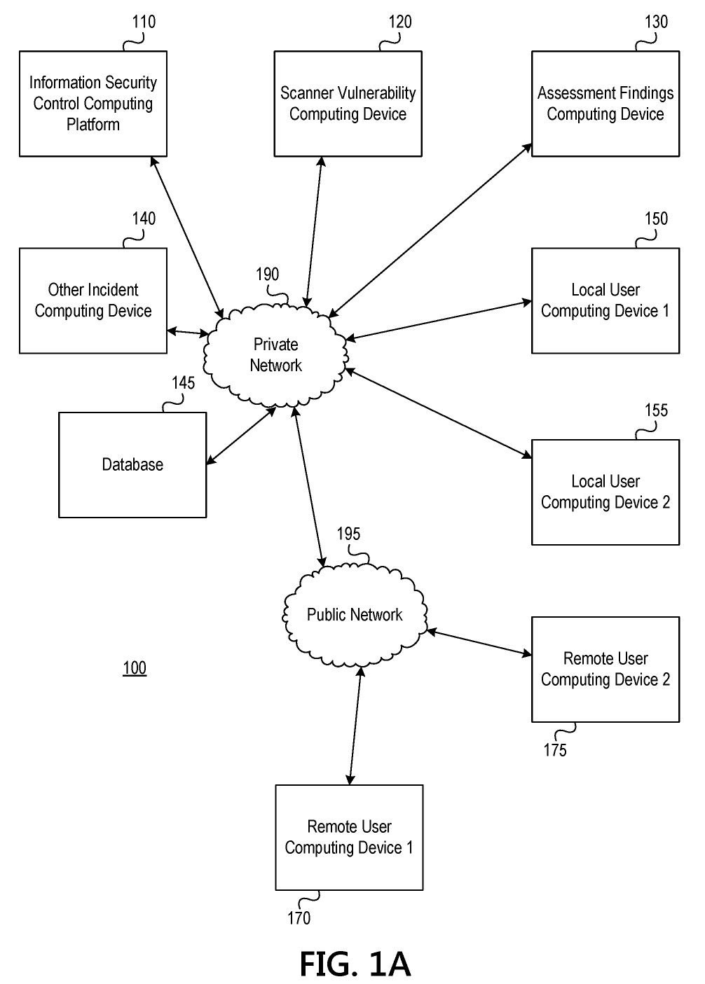

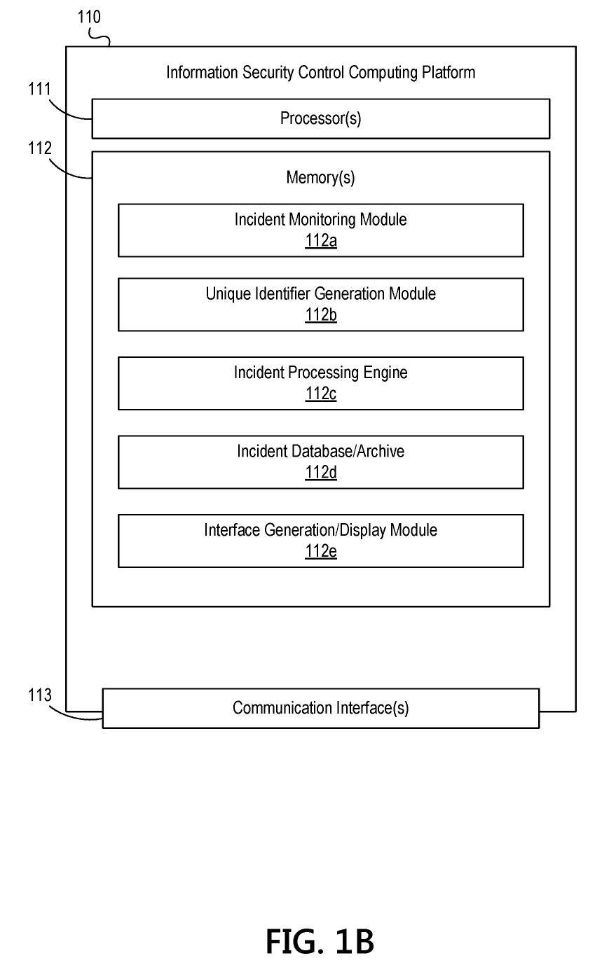

FIGS. 1A and 1B depict an illustrative computing environment for implementing and using an information security control computing system in accordance with one or more aspects described herein. Referring to FIG. 1A, computing environment 100 may include one or more computing devices and/or other computing systems. For example, computing environment 100 may include an information security control computing platform 110, a scanner vulnerability computing device 120, an assessment findings computing device 130, an other incident computing device 140, a database 145, a first local user computing device 150, a second local user computing device 155, a first remote user computing device 170, and a second remote user computing device 175.

Information security control computing platform 110 may be configured to host and/or execute various functions, as discussed in greater detail below. In some instances, information security control computing platform 110 may receive an incident or indication of an incident (e.g., from scanner vulnerability computing device 120, assessment findings computing device, other incident computing device 140, or the like) and may process the incident to extract information. The information security computing platform 110 may generate a unique identifier to associate with the incident and metadata associated with the incident, may store the extracted information, as well as metadata and the unique identifier, in a preconfigured database 145 (and/or incident database/archive 112d), may further process the incident upon resolution of the incident to extract and store additional information related to the resolution, and/or may generate one or more user interfaces to be displayed on one or more computing devices (e.g., local user computing device 150, local user computing device 155, remote user computing device 170, remote user computing device 175, or the like).

In some examples, computing and other devices, such as scanner vulnerability computing device 120, assessment findings computing device 130, other incident computing device 140, database 145, and the like, may be part of the information security control computing platform 110. In other examples, one or more of the scanner vulnerability computing device 120, assessment findings computing device 130, other incident computing device 140, database 145, or the like, may be separate devices from the information security control computing platform 110.

As indicated above, an information security incident may be received from one or more different sources (e.g., internal tools, third party tools, or the like). For instance, scanner vulnerability computing device 120 may include hardware and/or software and may be configured to monitor, store, collect and/or transmit data associated with one or more vulnerabilities. For instance, information security incidents or potential incidents may be detected via a software scanner, network crawler, or the like, by scanner vulnerability computing device 120. These incidents or potential incidents may be transmitted to the information security control computing platform 110 (e.g., via network 190) for processing. For example, a communications link may be established between one or more of the computing devices (e.g., scanner vulnerability computing device 120, assessment findings computing device 130, other incident computing device 140, and the like) and the information security control computing platform 110. While the communications link is active, the incident data may be transmitted from the respective computing device to the communications platform 110.

In another example, assessment findings computing device 130 may include hardware and/or software and may be configured to monitor, store, collect and/or transmit data associated with one or more assessment findings. For instance, an assessment of a device, software application, or the like, may be performed to evaluate operation, performance, or the like. The assessment may output one or more information security incidents or potential incidents that may be transmitted to the information security control computing platform 110 (e.g., via network 190) for further processing.

Other incident computing device 140 may include hardware and/or software and may be configured to monitor, store, collect and/or transmit data associated with one or more other incidents that might not be captured by scanner vulnerability computing device 120 and/or assessment findings computing device 130. For instance, other incident computing device 140 may detect information security incidents or potential incidents associated with an access revocation request which is delayed or remains open for a period of time greater than a predetermined threshold period of time, an open share that holds non-public information, and the like. In some examples, other incident computing device 140 may receive a manually entered incident or potential incident, e.g., via one or more of local user computing device 150, local user computing device 155, remote user computing device 170, and/or remote user computing device 175.

Local user computing device 150, 155 and remote user computing device 170, 175 may be configured to communicate with and/or connect to one or more computing devices or systems shown in FIG. 1A. For instance, local user computing device 150, 155 may communicate with one or more computing systems or devices via network 190, while remote user computing device 170, 175 may communicate with one or more computing systems or devices via network 195. The local and remote user computing devices may be used to provide access one or more systems, devices, computing platforms, and the like, as well as to display one or more user interfaces, as will be discussed more fully below.

In one or more arrangements, scanner vulnerability computing device 120, assessment findings computing device 130, other vulnerability computing device 140, local user computing device 150, local user computing device 155, remote user computing device 170, and remote user computing device 175 may be any type of computing device capable of receiving a user interface, receiving input via the user interface, and communicating the received input to one or more other computing devices. For example, scanner vulnerability computing device 120, assessment findings computing device 130, other incident computing device 140, local user computing device 150, local user computing device 155, remote user computing device 170, and remote user computing device 175 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of system associated with scanner vulnerability computing device 120, assessment findings computing device 130, other incident computing device 140, local user computing device 150, local user computing device 155, remote user computing device 170, and remote user computing device 175 may, in some instances, be special-purpose computing devices configured to perform specific functions.

Computing environment 100 also may include one or more computing platforms. For example, and as noted above, computing environment 100 may include information security control computing platform 110. As illustrated in greater detail below, information security control computing platform 110 may include one or more computing devices configured to perform one or more of the functions described herein. For example, information security control computing platform 110 may include one or more computers (e.g., laptop computers, desktop computers, servers, server blades, or the like).

As mentioned above, computing environment 100 also may include one or more networks, which may interconnect one or more of information security control computing platform 110, scanner vulnerability computing device 120, assessment findings computing device 130, other incident computing device 140, local user computing device 150, local user computing device 155, remote user computing device 170, and remote user computing device 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, information security control computing platform 110, scanner vulnerability computing device 120, assessment findings computing device 130, other incident computing device 140, data base 145, local user computing device 150, and local user computing device 155 may be associated with an organization (e.g., a financial institution), and private network 190 may be associated with and/or operated by the organization, and may include one or more networks (e.g., LANs, WANs, virtual private networks (VPNs), or the like) that interconnect information security control computing platform 110, scanner vulnerability computing device 120, assessment findings computing device 130, other incident computing device 140, data base 145, local user computing device 150, and local user computing device 155 and one or more other computing devices and/or computer systems that are used by, operated by, and/or otherwise associated with the organization. Public network 195 may connect secure, private network 190 and/or one or more computing devices connected thereto (e.g., information security control computing platform 110, scanner vulnerability computing device 120, assessment findings computing device 130, other incident computing device 140, data base 145, local user computing device 150, and/or local user computing device 155) with one or more networks and/or computing devices that are not associated with the organization. For example, remote user computing device 170 and remote user computing device 175 might not be associated with an organization that operates private network 190 (e.g., because remote user computing device 170 and remote user computing device 175 may be owned, operated, and/or serviced by one or more entities different from the organization that operates private network 190, such as one or more customers of the organization and/or vendors of the organization, rather than being owned and/or operated by the organization itself or an employee or affiliate of the organization), and public network 195 may include one or more networks (e.g., the internet) that connect remote user computing device 170 and remote user computing device 175 to private network 190 and/or one or more computing devices connected thereto (e.g., information security control computing platform 110, scanner vulnerability computing device 120, assessment findings computing device 130, other incident computing device 140, data base 145, local user computing device 150, and/or local user computing device 155).

Referring to FIG. 1B, information security control computing platform 110 may include one or more processors 111, memory 112, and communication interface 113. A data bus may interconnect processor(s) 111, memory 112, and communication interface 113. Communication interface 113 may be a network interface configured to support communication between information security control computing platform 110 and one or more networks (e.g., private network 190, public network 195, or the like). Memory 112 may include one or more program modules having instructions that when executed by processor(s) 111 cause information security control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of information security control computing platform 110 and/or by different computing devices that may form and/or otherwise make up information security control computing platform 110. For example, memory 112 may have, store, and/or include an incident monitoring module 112a. The incident monitoring module 112a may store and/or include instructions and/or data that may cause or enable the information security control computing platform 110 to monitor devices configured to detect information security incidents, such as scanner vulnerability computing device 120, assessment findings computing device 130, other incident computing device 140, and the like. In some examples, the incident monitoring module 112a may continuously monitor, in real-time or near real-time, a content stream from each device to identify one or more information security incidents or potential incidents. Continuous monitoring of the devices, content streams, and the like, may permit the fastest and most efficient response to an identified incident. The incident monitoring module 112a may then receive an indication of an information security incident for further processing.

Memory 112 may further have, store and/or include a unique identifier generation module 112b. The unique identifier generation module 112b may have or store instructions and/or data that may cause or enable the information security control computing platform 110 to generate a unique identifier for an identified incident. In some examples, the unique identifier may be a numeric or alphanumeric identifier generated upon receipt of an indication of an information security incident. The unique identifier may be a randomly generated string of characters. In other examples, the unique identifier may be generated based on one or more characteristics or features of the information security incident, device or application impacted by or at which the incident was detected, and the like. For example, a unique identifier may include one or more characters identifying a type or name of incident detected and one or more characters identifying a device, application, or the like, at which the incident was detected. In some examples, the characters identifying the type or name of the incident may be followed by the characters identifying the device or application. Alternatively, the characters identifying the type device or application may be followed by the characters identifying the type or name of the incident.

Memory 112 may further have, store, and/or include an incident processing engine 112c. The incident processing engine 112c may have or store instructions and/or data that may cause or enable the information security control computing platform 110 to process data associated with an identified information security incident. For example, the incident processing engine 112c may receive the indication of an information security incident, as well as data associated with the incident. The data associated with the incident, in at least some examples, may include metadata captured with the incident. The incident processing engine 112c may receive the unique identifier generated in response to detection of the incident and may associate the unique identifier with the incident, data associated with the incident (including, for example, metadata) and the like. In some examples, associating the unique identifier with the incident, data associated with the incident, and the like, may include watermarking (e.g., digital watermarking) the incident, data associated with the incident, and the like, with the unique identifier in order to enable tracking of the incident, data within or associated with the incident, frequency of occurrence of the incident, devices or applications impacted by similar incidents, and the like.

The incident processing engine 112c may further process the data associated with the incident to extract data and transmit the data for storage in a database, such as database 145 and/or incident database/archive 112d. In some examples, the database 145 and/or incident database/archive 112d may have a predetermined data structure such that the incident processing engine 112c may extract particular types of data for storage. Accordingly, upon extracting the data related to the incident (the data being watermarked with the unique identifier), the data may be transmitted to database 145 and/or incident database/archive 112d for storage. In some examples, database 145 and/or incident database/archive 112d may include a master table storing data related to all detected information security incidents.

Accordingly, based on the predetermined data structure, the incident processing engine 112c may map extracted data based on the predetermined data structure, one or more predetermined business rules, and the like. For example, the incident processing engine 112c may map information such as application or device impacted by the incident, line or business or owner of the device or application impacted by the incident, risk exception information, associate information, and the like.

In some arrangements, database 145 and/or incident database/archive 112d may be a relational database. In other examples, database 145 and/or incident database/archive 112d may be a non-relational, column-oriented database. In some examples, database 145 and incident database/archive 112d may be a same database or portions of a same database. In other examples, database 145 and incident database/archive 112d may be separate databases.

In some examples, incident processing engine 112c may receive information related to an incident after an initial indication of the incident. For instance, one or more of scanner vulnerability computing device 120, assessment findings computing device 130, other incident computing device 140, may transmit information related to the incident. The information may be received by the incident processing engine 112c and may be processed to update a data record associated with the incident. In some examples, information received may include information related to remediation of the incident, information related to ownership of the incident or device or application associated with the incident, and the like.

In some arrangements, incident processing engine 112c may process all incidents in the database 145 and/or incident database archive 112d on a periodic or aperiodic basis to update any open items with any addition received information. In other examples, processing may be performed in response to a triggering event (e.g., on a particular day of week, day or month, time of day, upon receipt of a new incident, and the like). In some examples, incident processing engine 112c may be configured to re-process or re-run data to remove changes made to the incident data (e.g., a most recent update, any changes may since previous processing, or the like). Incidents to be re-run or re-processed may be flagged. In some examples, the flag to re-process or re-run data may be manually placed on an incident or data record. In other examples, the flag may be placed upon determination of a triggering event (e.g., an inconsistency in the data, detection of a duplicate incident or record of an incident, or the like). Data may be re-run or re-processed on a periodic or a-periodic basis, and/or upon receipt of a triggering event (e.g., threshold number of re-run flags detected, or the like).

Memory 112 may further have, store and/or include an interface generation/display module 112e. The interface generation/display module 112e may have or store instructions and/or data that may cause or enable the information security computing platform 110 to generate one or more user interfaces and cause the interfaces to be displayed on one or more computing devices, such as local user computing device 150, local user computing device 155, remote user computing device 170, and/or remote user computing device 175. The interface generation/display module 112e may generate one or more user interfaces that may enable tracking of incidents, viewing of historical data related to incidents, and the like. In some examples, the interface generation/display module 112e may receive user input requesting particular data for display and may generate an interface including the requested data. The data may then be transmitted to one or more computing devices and the interface generation/display module 112e may cause the interface to be displayed on the computing device.

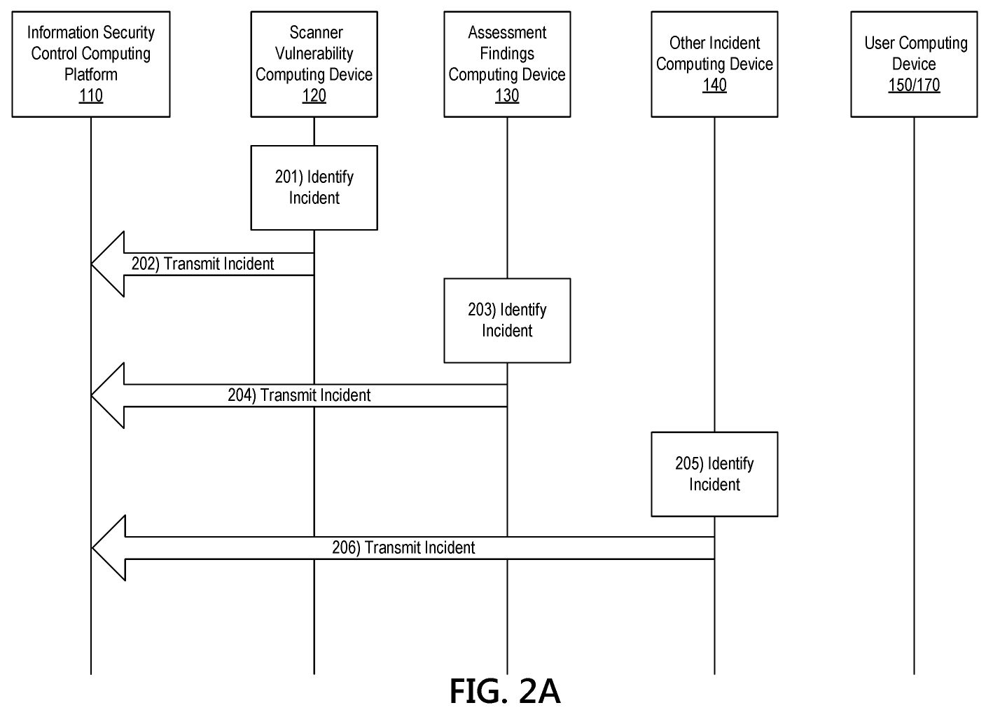

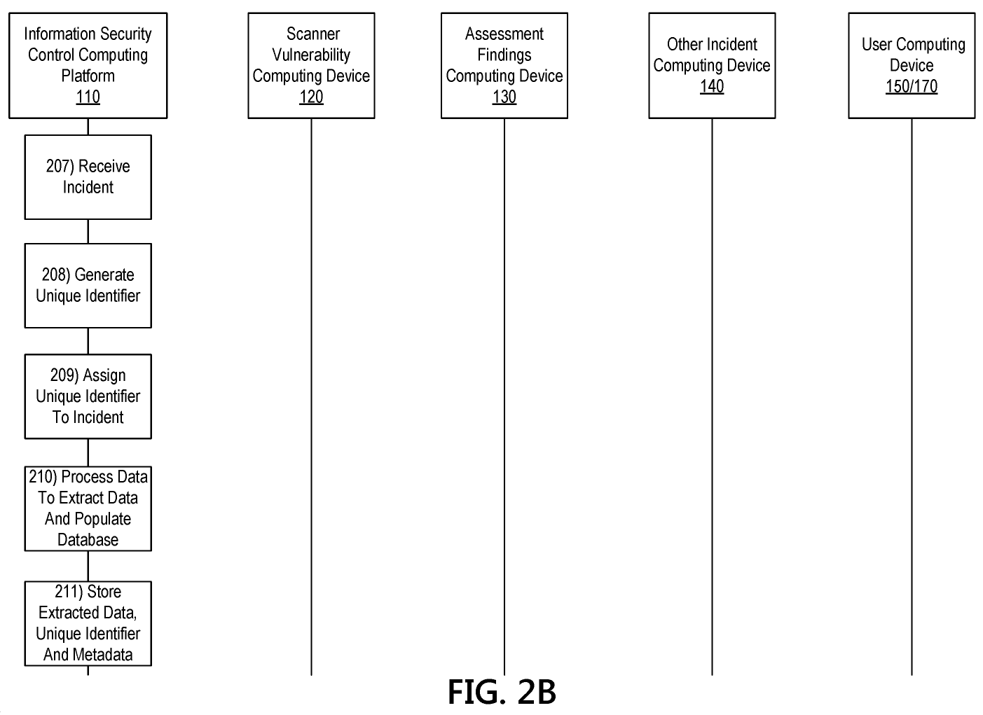

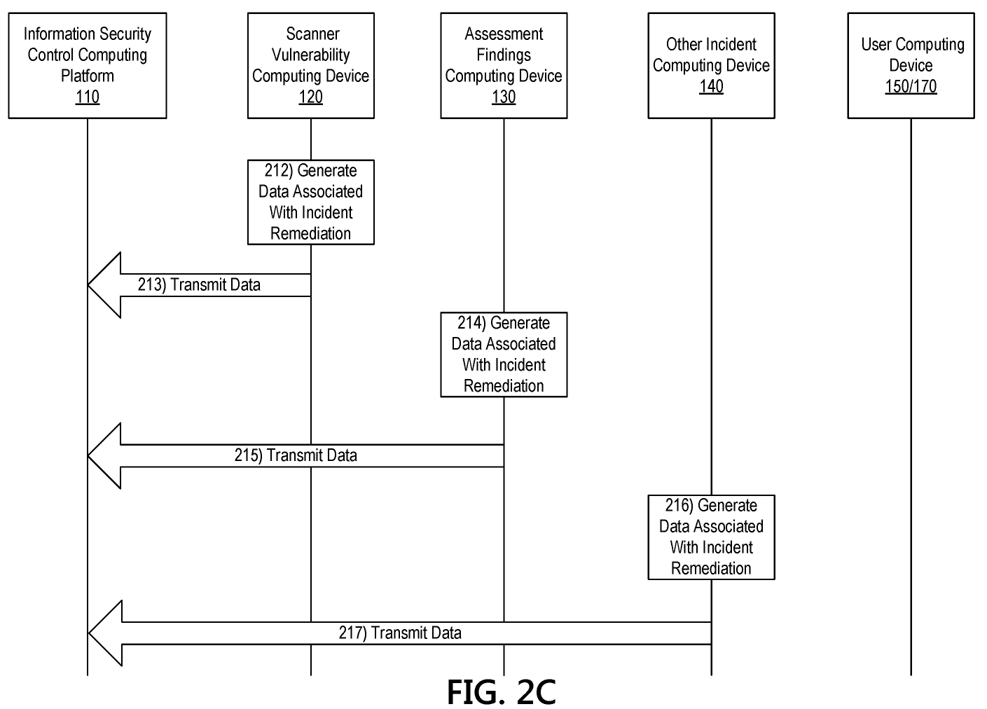

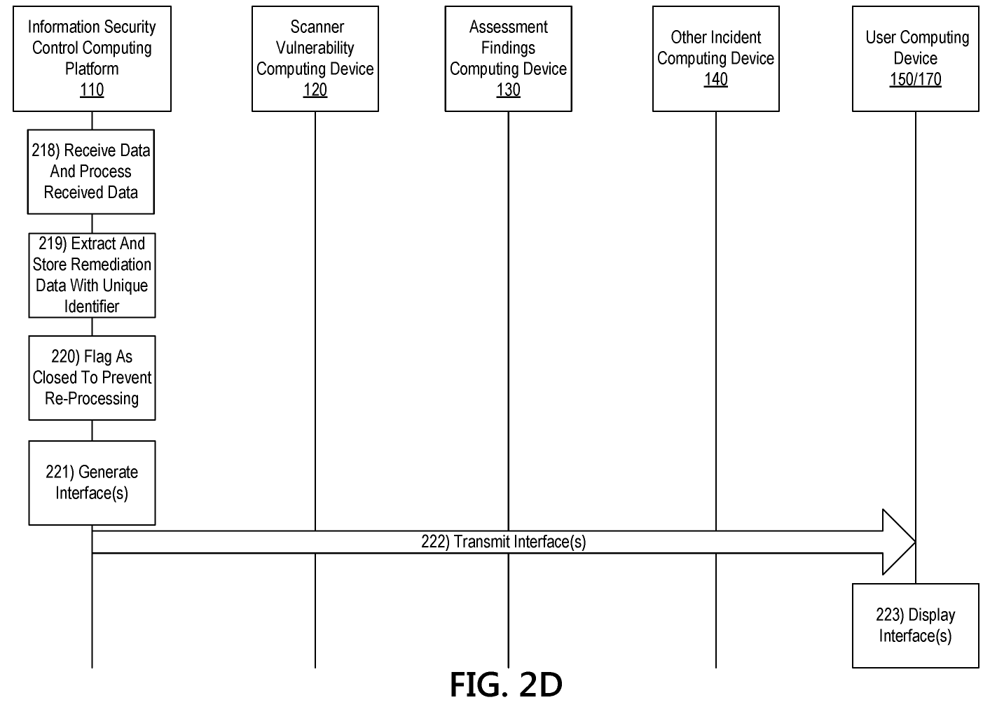

FIGS. 2A-2D depict an illustrative event sequence for implementing and using information security control computing platform and associated computing systems and devices to perform information security control functions in accordance with one or more aspects described herein. The events shown in the illustrative event sequence are merely one example sequence and additional events may be added, or events may be omitted, without departing from the invention.

Referring to FIG. 2A, at step 201, an information security incident may be detected by, for example, scanner vulnerability computing device 120 and may be transmitted to the information security computing platform 110 in step 202. Additionally or alternatively, in step 203, an information security incident may be detected by assessment findings computing device 130 and transmitted to the information security control computing platform 110 in step 204. Additionally or alternatively, an information security incident may be detected by other incident computing device 140 in step 205 and transmitted to the information security control computing platform 110 in step 206.

Each of steps 201, 203 and 205 may be performed in simultaneously or nearly simultaneously. Further, one or more of steps 201, 203, and 205 (and corresponding transmitting steps) may be omitted when an incident is not detected by the respective device. Accordingly, an incident may be received from one device, two devices or three devices.

With reference to FIG. 2B, in step 207, the transmitted incident(s) may be received by the information security control computing platform 110. In step 208, a unique identifier may be generated for a received incident. In some examples, a unique identifier may be generated for each incident received. As discussed above, the unique identifier may be a numeric or alphanumeric string of characters that may be randomly generated or may be generated based on features of the incident, such as name or type of incident, device or application impacted by the incident, or the like.

In step 209, the generated unique identifier may be assigned to, associated with, or the like, the received incident. For instance, the incident, as well as data associated with the incident, metadata, and the like, may be watermarked (e.g., digitally watermarked) with the unique identifier to enable tracking of the incident, one or more portions of the data associated with the incident, and the like.

In step 210, the incident and associated data may be processed by, for example, the incident processing engine 112c of the information security control computing platform 110. Processing the data may include extracting data from the incident data received and populating a data structure with the extracted data according to a predefined data structure configuration. In step 211, the extracted data (and associated unique identifier) may be stored in according to the predefined data structure.

With reference to FIG. 2C, additional information related to an incident may be received. For instance, data associated with remediation of an incident may be received. In step 212, data associated with remediation of an incident may be generated or received by, for example, scanner vulnerability computing device 120. The information may be transmitted to the information security computing platform 110 in step 213.

Similarly, for incidents received from other devices, in step 214, data associated with remediation of an incident may be generated by or received by assessment findings computing device 130 and transmitted to the information security control computing platform 110 in step 215. In step 216, data associated with remediation may be received by or generated by other incident computing device 140 and transmitted to the information security control computing platform 110 in step 217.

Similar to arrangements described above, remediation may be received from one, two, three or more computing devices.

With reference to FIG. 2D, the additional data transmitted (e.g., data associated with remediation of an incident or additional data associated with the incident) may be received by the information security control computing platform 110 and processed in step 218. In step 219, data from the received data may be extracted and stored with the unique identifier and other incident data in the data structure. In some examples, if remediation efforts are complete, the incident may be flagged as being completed in step 220. Accordingly, the system may process an incident flagged as completed one additional time in order to capture all data associated with remediation efforts and then might not further process the incident identified as closed. The final processing of the incident after being identified as closed may permit the information security control computing platform 110 to capture all data associated with the closed matter and store the data to enable tracking of the incident, remediation of the incident, and the like.

In step 221, one or more user interfaces may be generated by the information security control computing platform 110. For instance, a user interface may be generated to provide tracking information to a user, provide incident and/or remediation information to a user, provide trend or other historical information to a user, and the like. The interface may be generated, for example, by interface generation/display module 112e.

In step 222, the one or more generated interfaces may be transmitted to a computing device, such as local user computing device 150, local user computing device 155, remote user computing device 170, remote user computing device 175. In step 223, the information security control computing platform 110 may cause the transmitted interface(s) to be displayed on the computing device. For instance, the information security control computing platform 110 may transmit a command, instruction, or signal to display the one or more interfaces.

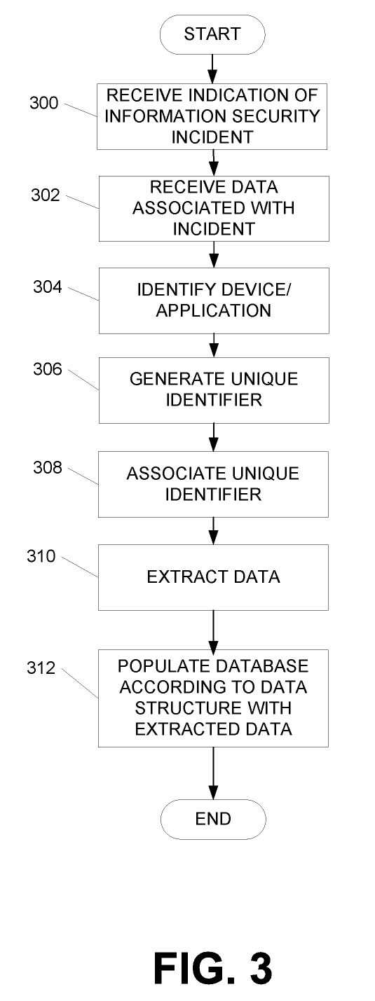

FIG. 3 is a flow chart illustrating one example method of providing information security control functions according to one or more aspects described herein. In step 300, an indication of an information security incident may be received. For instance, an indication of an information security incident may be received from one or more of scanner vulnerability computing device 120, assessment findings computing device 130, other incident computing device 140, or the like. In some examples, the indication may be received a continuous monitoring of a content stream received by the information security control computing platform 110 and from one or more of the devices.

In step 302, data associated with the identified incident may be received. In some examples, the data may include metadata associated with the incident. In step 304, the received data may be analyzed to identify one of a device or application associated with the incident. In step 306, a unique identifier may be generated for the incident. In some examples, the unique identifier may be determined and/or generated based on a name or type of incident and the identified device or application associated with the incident.

In step 308, the unique identifier may be associated with the incident and/or data associated with the incident. In some examples, the incident and/or incident data may be watermarked with the unique identifier to enable tracking.

In step 310, data may be extracted from the received data and, in step 312, a record may be created in a database. The record may be populated with the extracted data according to a pre-configured data structure.

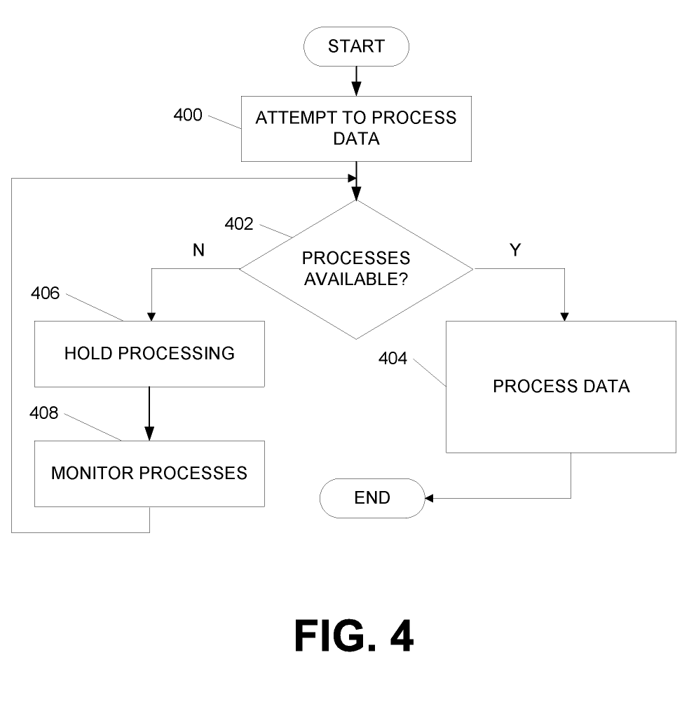

FIG. 4 illustrates one example method of determining whether processing of data and/or certain functions associated with the data processing are available in accordance with one or more aspects described herein. In step 400, an attempt to process data may be made. In some examples, attempting to process data may include attempting to extract data, attempting to generate a data record in a database, attempting to populate a database according to a pre-configured data structure, and the like.

In step 402, a determination is made as to whether one or more processes are available. For instance, if another process or function is running, one or more processes may be unavailable. Accordingly, if, in step 402, the desired process or processes are available, the data may be processed in step 404.

Alternatively, if, in step 402, it is determined that one or more processes are not available, the information security control computing platform 110 may hold processing of the data in step 406 and may monitor the processes in step 408. The process may then return to step 402 to determine whether the process or processes are available.

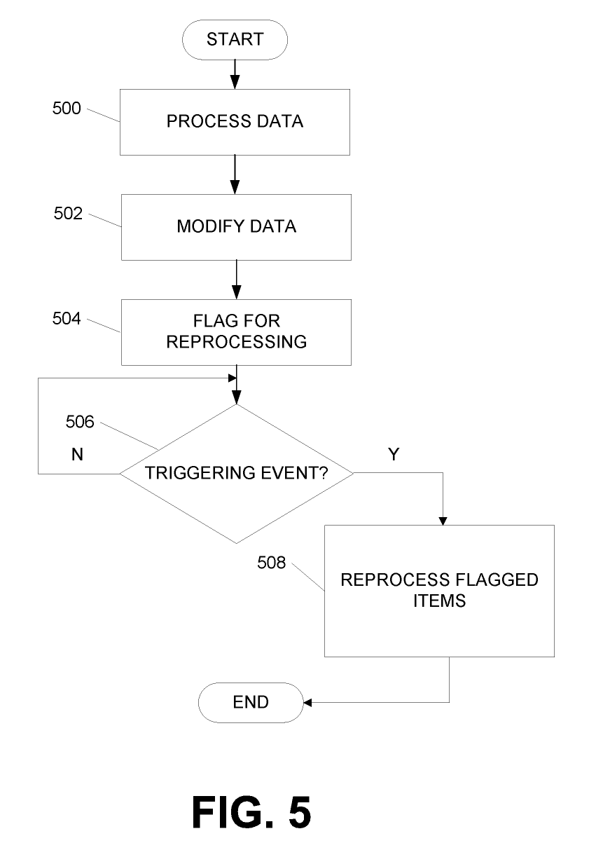

FIG. 5 illustrates one example of re-processing data according to one or more aspects described herein. In step 500, data, such as data associated with an information security incident, may be processed. In some examples, processing the data may include modifying the data in step 502. For instance, data associated with an information security incident may be processed to include updated information, remediation information, and the like.

In step 504, one or more data records (e.g., records in database associated with an information security incident) may be flagged for re-processing. Re-processing may include removing one or more changes to the flagged data. For example, in some arrangements, all changes made to data may be removed during reprocessing. In another example, most recent changes made to data may be removed in re-processing.

In some arrangements, items may be flagged for reprocessing by a user, such as a system administrator. In other examples, items may be flagged for reprocessing by the system. For instance, if the system detects a duplicate record, an inconsistency in a record, or another criteria, the system may flag the record for re-processing.

In step 506, a determination may be made as to whether a re-processing triggering event has occurred. For instance, the system may determine whether one or more predefined criteria for triggering re-processing of cases flagged for re-processing has occurred. In some examples, a triggering event may include expiration of a predetermined amount of time, occurrence of a particular time of day, day of week, day of month, or the like. In other examples, triggering events may include identification of a threshold number of items flagged for re-processing, or the like.

If, in step 506, a triggering event has occurred, the system may re-process flagged items in step 508. As indicated above, re-processing flagged items may include removing one or more changes or modifications made to the data.

If, in step 506, a triggering event has not occurred, the system may continue to monitor for a triggering event and may return to step 506.

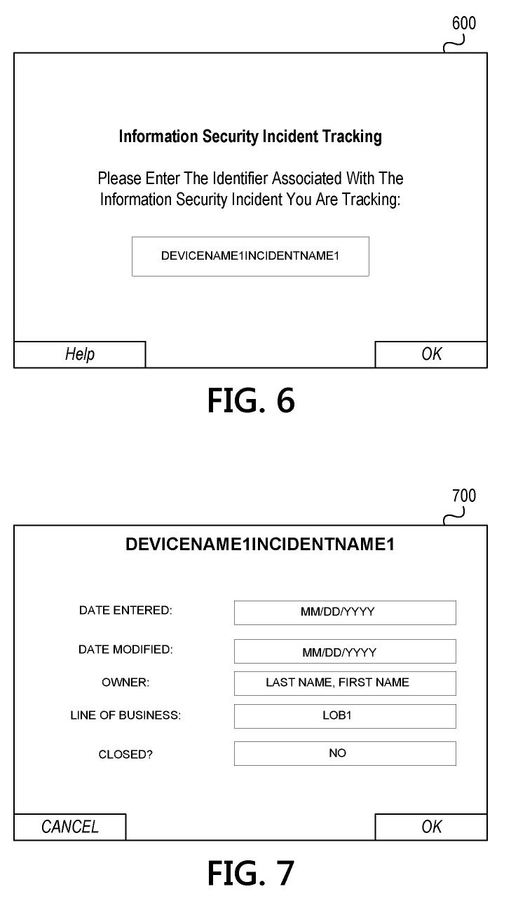

FIG. 6 illustrates one example user interface for requesting information related to an information security incident according to one or more aspects described herein. Interface 600 may be generated, for example, by interface generation/display module 112e. The interface 600 includes a field to enter a unique identifier associated with an incident.

FIG. 7 illustrates one example user interface for providing information related to an information security incident according to one or more aspects described herein. Interface 700 may be generated, for example, by interface generation/display module 112e. The interface 700 may include data associated with a date the incident was entered into the system, dates of any modifications made to the data set, an owner of the incident, a line of business associated with the incident, an indication of whether the incident is closed, or the like. Additional information may also be provided in interface 700, or similar interfaces, without departing from the invention.

The arrangements described herein provide for efficient, scalable systems for tracking information security incidents. By associating a unique identifier with each information security incident, tracking of incidents, remediation efforts, outcomes, and the like, may be performed efficiently and accurately. In addition, historical reporting of incidents, both open and closed, may be performed accurately. Further, information such as owner of an incident, device or application, users modifying data, dates of data modification, and the like, may be logged and tracked by the systems and arrangements described herein. One or more reports including various metrics may be generated to provide tracking information, historical information, and the like.

The arrangements described herein also provide for scalable systems. For instance, one or more additional incident processing engines may be added as needed. In some examples, the additional incident processing engines may be built using one or more configurations of, for example, incident processing engine 112c (e.g., a core or parent incident processing engine). Accordingly, this ability to add additional incident processing engines (and, thus, incident processing capabilities) based on a configuration of another incident processing engine (e.g., incident processing engine 112c) may improve not only the speed with which incidents are processed, but also the accuracy of processing, data quality, and the like, because a single configuration is used to build the additional incident processing engines.

In addition, as additional incident detection processes are implemented, devices or applications are added or removed, and the like, changes may be made via the information security control computing platform without requiring multiple changes to different code, different devices, and the like.

Further, shared routines may be processed through a single point in code to allow for consistent behavior and single-point changes. Also, downstream tools can optionally be configured to flow data back into the information security control computing platform (e.g., incident processing engine 112c) for processing.

The aspects described herein provide systems, arrangements, and the like, for modifying, updating, or the like, vast amounts of data relatively easily by providing a pipeline to implement changes uniformly, accurately, and efficiently. Unlike conventional systems in which users may capture snapshots of data to track open incidents, individual data sets may be coded differently, and the like, the arrangements described herein provide the ability to quickly and accurately modify or update data, or add new data sets, new devices, incidents, applications, or the like, using a consistent process that enables tracking of incidents, both open and closed.

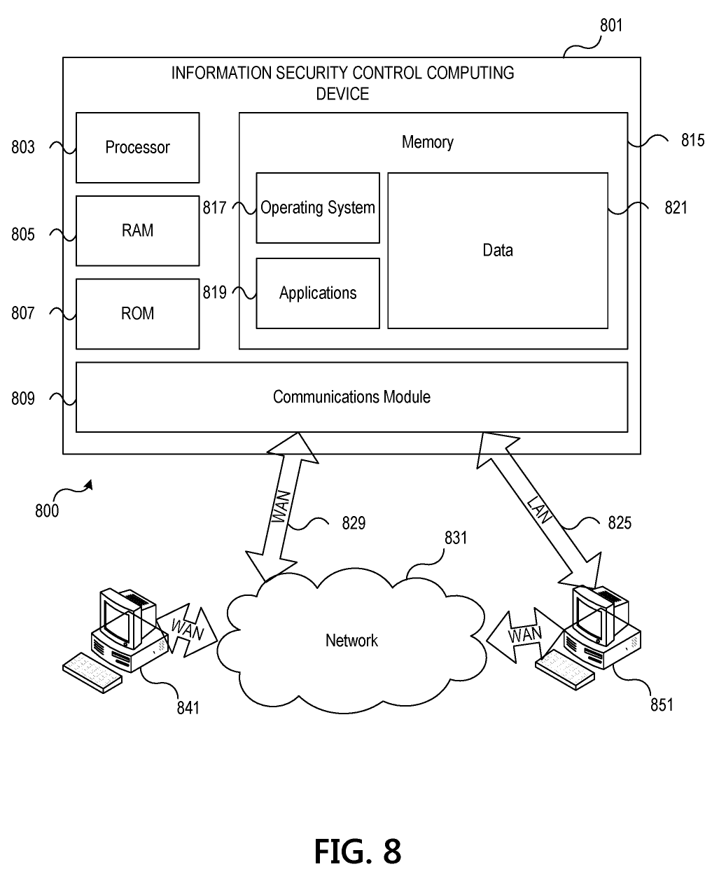

FIG. 8 depicts an illustrative operating environment in which various aspects of the present disclosure may be implemented in accordance with one or more example embodiments. Referring to FIG. 8, computing system environment 800 may be used according to one or more illustrative embodiments. Computing system environment 800 is only one example of a suitable computing environment and is not intended to suggest any limitation as to the scope of use or functionality contained in the disclosure. Computing system environment 800 should not be interpreted as having any dependency or requirement relating to any one or combination of components shown in illustrative computing system environment 800.

Computing system environment 800 may include information security control computing device 801 having processor 803 for controlling overall operation of information security control computing device 801 and its associated components, including Random-Access Memory (RAM) 805, Read-Only Memory (ROM) 807, communications module 809, and memory 815. Information security control computing device 801 may include a variety of computer readable media. Computer readable media may be any available media that may be accessed by information security control computing device 801, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by computing device 801.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on information security control computing device 801. Such a processor may execute computer-executable instructions stored on a computer-readable medium.

Software may be stored within memory 815 and/or storage to provide instructions to processor 803 for enabling information security control computing device 801 to perform various functions. For example, memory 815 may store software used by information security control computing device 801, such as operating system 817, application programs 819, and associated database 821. Also, some or all of the computer executable instructions for information security control computing device 801 may be embodied in hardware or firmware. Although not shown, RAM 805 may include one or more applications representing the application data stored in RAM 805 while information security control computing device 801 is on and corresponding software applications (e.g., software tasks) are running on information security control computing device 801.

Communications module 809 may include a microphone, keypad, touch screen, and/or stylus through which a user of information security control computing device 801 may provide input, and may also include one or more of a speaker for providing audio output and a video display device for providing textual, audiovisual and/or graphical output. Computing system environment 800 may also include optical scanners (not shown). Exemplary usages include scanning and converting paper documents, e.g., correspondence, receipts, and the like, to digital files.

Information security control computing device 801 may operate in a networked environment supporting connections to one or more remote computing devices, such as computing devices 841 and 851. Computing devices 841 and 851 may be personal computing devices or servers that include any or all of the elements described above relative to information security control computing device 801.

The network connections depicted in FIG. 8 may include Local Area Network (LAN) 825 and Wide Area Network (WAN) 829, as well as other networks. When used in a LAN networking environment, information security control computing device 801 may be connected to LAN 825 through a network interface or adapter in communications module 809. When used in a WAN networking environment, information security control computing device 801 may include a modem in communications module 809 or other means for establishing communications over WAN 829, such as network 831 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like and are configured to perform the functions described herein.

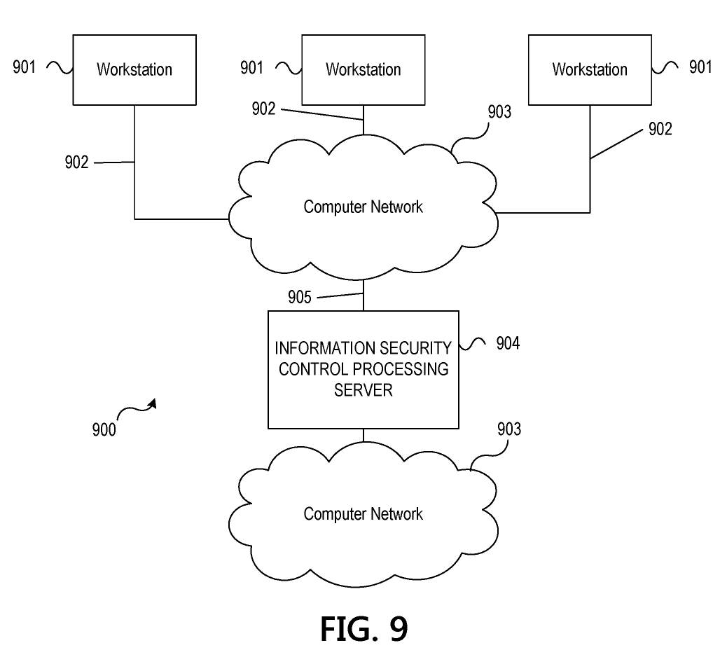

FIG. 9 depicts an illustrative block diagram of workstations and servers that may be used to implement the processes and functions of certain aspects of the present disclosure in accordance with one or more example embodiments. Referring to FIG. 9, illustrative system 900 may be used for implementing example embodiments according to the present disclosure. As illustrated, system 900 may include one or more workstation computers 901. Workstation 901 may be, for example, a desktop computer, a smartphone, a wireless device, a tablet computer, a laptop computer, and the like, configured to perform various processes described herein. Workstations 901 may be local or remote, and may be connected by one of communications links 902 to computer network 903 that is linked via communications link 905 to information security control processing server 904. In system 900, information security control processing server 904 may be any suitable server, processor, computer, or data processing device, or combination of the same, configured to perform the functions and/or processes described herein. Server 904 may be used to process received incident data, generate a unique identifier, extract data, and the like.

Computer network 903 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. Communications links 902 and 905 may be any communications links suitable for communicating between workstations 901 and information security control processing server 904, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. An information security control computing platform, comprising:
at least one processor;
a communication interface communicatively coupled to the at least one processor; and
memory storing computer-readable instructions that, when executed by the at least one processor, cause the information security control computing platform to:
receive an indication of an information security incident;
receive data associated with the information security incident;
determine at least one of: an application and device associated with the information security incident;
generate, based on the information security incident and the determined at least one of: an application and device associated with the information security incident, a unique identifier associated with the information security incident;
watermark the data associated with the information security incident with the generated unique identifier;
extract, from the data associated with the information security incident, information associated with the information security incident; and
store, in a database storing a plurality of information security incidents, the extracted information associated with the information security incident and the unique identifier.

2. The information security control computing platform of claim 1, wherein the extracted information is stored in the database according to a pre-configured data structure.

3. The information security control computing platform of claim 1, wherein the information security incident is at least one of: a vulnerability from a network scanner, a finding from an internal penetration test, a finding from a third party assessment, an access revocation request, and an open share that holds non-public information.

4. The information security control computing platform of claim 1, wherein the generated unique identifier includes characters associated with an application identifier and characters associated with an issue name associated with the information security incident.

5. The information security control computing platform of claim 1, wherein the generated unique identifier includes characters associated with a device identifier and characters associated with an issue name associated with the information security incident.

6. The information security control computing platform of claim 1, wherein the received data associated with the information security incident includes metadata associated with the information security incident.

7. The information security control computing platform of claim 6, wherein storing the extracted information further includes storing the metadata associated with the information security incident.

8. The information security control computing platform of claim 1, further including instructions that, when executed, cause the information security control computing platform to:
flag a first information security incident of the plurality of information security incidents stored in the database for re-processing.

9. The information security control computing platform of claim 8, further including instructions that, when executed, cause the information security control computing platform to:
receive an indication of a triggering event; and
responsive to receiving an indication of a triggering event, re-processing the first information security incident flagged for re-processing.

10. The information security control computing platform of claim 9, wherein the triggering event includes expiration of a predetermined time period.

11. A method, comprising:
at a computing platform comprising at least one processor, memory, and a communication interface:
receiving, by the at least one processor and via the communication interface, an indication of an information security incident;
receiving, by the at least one processor and via the communication interface, data associated with the information security incident;
determining, by the at least one processor, at least one of: an application and device associated with the information security incident;
generating, by the at least one processor and based on the information security incident and the determined at least one of: an application and device associated with the information security incident, a unique identifier associated with the information security incident;
watermarking, by the at least one processor, the data associated with the information security incident with the generated unique identifier;
extracting, by the at least one processor and from the data associated with the information security incident, information associated with the information security incident; and
storing, by the at least one processor and in a database storing a plurality of information security incidents, the extracted information associated with the information security incident and the unique identifier.

12. The method of claim 11, wherein the extracted information is stored in the database according to a pre-configured data structure.

13. The method of claim 1, wherein the information security incident is at least one of: a vulnerability from a network scanner, a finding from an internal penetration test, a finding from a third party assessment, an access revocation request, and an open share that holds non-public information.

14. The method of claim 11, wherein the generated unique identifier includes characters associated with an application identifier and characters associated with an issue name associated with the information security incident.

15. The method of claim 11, wherein the generated unique identifier includes characters associated with a device identifier and characters associated with an issue name associated with the information security incident.

16. The method of claim 11, wherein the received data associated with the information security incident includes metadata associated with the information security incident.

17. The method of claim 11, further including:
flagging, by the at least one processor, a first information security incident of the plurality of information security incidents stored in the database for re-processing.

18. The method of claim 17, further including:
receiving, by the at least one processor, an indication of a triggering event; and
responsive to receiving an indication of a triggering event, re-processing the first information security incident flagged for re-processing.

19. One or more non-transitory computer-readable media storing instructions that, when executed by a computing platform comprising at least one processor, memory, and a communication interface, cause the computing platform to:
receive, via the communication interface, an indication of an information security incident;
receive, via the communication interface, data associated with the information security incident;
determine at least one of: an application and device associated with the information security incident;
generate, based on the information security incident and the determined at least one of: an application and device associated with the information security incident, a unique identifier associated with the information security incident;
watermark the data associated with the information security incident with the generated unique identifier;
extract, from the data associated with the information security incident, information associated with the information security incident; and
store, in a database storing a plurality of information security incidents, the extracted information associated with the information security incident and the unique identifier.

20. The one or more non-transitory computer-readable media of claim 19, wherein the extracted information is stored in the database according to a pre-configured data structure.

21. The one or more non-transitory computer-readable media of claim 19, wherein the information security incident is at least one of: a vulnerability from a network scanner, a finding from an internal penetration test, a finding from a third party assessment, an access revocation request, and an open share that holds non-public information.

22. The one or more non-transitory computer-readable media of claim 19, wherein the generated unique identifier includes characters associated with an application identifier and characters associated with an issue name associated with the information security incident.

23. The one or more non-transitory computer-readable media of claim 19, wherein the generated unique identifier includes characters associated with a device identifier and characters associated with an issue name associated with the information security incident.

24. The one or more non-transitory computer-readable media of claim 19, wherein the received data associated with the information security incident includes metadata associated with the information security incident.

25. The one or more non-transitory computer-readable media of claim 19, further including instructions that, when executed, cause the computing platform to:
flag a first information security incident of the plurality of information security incidents stored in the database for re-processing.

26. The one or more non-transitory computer-readable media of claim 25, further including instructions that, when executed, cause the computing platform to:
receive an indication of a triggering event; and
responsive to receiving an indication of a triggering event, re-processing the first information security incident flagged for re-processing.
